(19) United States
(12) Patent Application Publication
(10) Pub. No.: US 2026/0252673 A1
(43) Pub. Date: Aug. 27, 2026

(54) BIOMETRIC AUTHENTICATION-BASED ACCESS TO DISPLAYED DOCUMENTS OR CONTENT WITH MODIFIABLE FREQUENCY OR SCHEDULE FOR TRIGGERING AUTHENTICATION PROCESSES

(71) Applicant: Microsoft Technology Licensing, LLC, Redmond, WA (US)

(72) Inventors: Katharine Ormond HOLDSWORTH, Kirkland, WA (US); Abhilasha BHARGAV-SPANTZEL, El Dorado Hills, CA (US); Md. Nazmus SAKIB, Seattle, WA (US); Ayobami Peter OLATUNJI, Seattle, WA (US)

(73) Assignee: Microsoft Technology Licensing, LLC, Redmond, WA (US)

(21) Appl. No.: 19/062,434

(22) Filed: Feb. 25, 2025

(51) Int. Cl. G06F 21/32

(52) U.S. Cl. CPC G06F 21/32

(57) ABSTRACT

Systems and methods are provided for implementing biometric authentication-based access to displayed documents or content with modifiable frequency or schedule for triggering authentication processes. A computing system receives a plurality of data including at least one of location data indicating a current location of the computing system, user access level data indicating an access level of a first user accessing one or more documents on the computing system, or document security level data indicating a security level for each document among the one or more documents being accessed. The computing system determines a security risk level for display of the one or more documents on a display screen of the computing system while the computing system is located within the current location, based on a combination of data among the plurality of data. The computing system sets or modifies a frequency and/or a schedule for triggering an authentication verification process.

### BACKGROUND

As users become comfortable with working everywhere, like airports, coffee shops, restaurants, etc., attackers are using various tricks and tactics in obtaining sensitive information from devices of such users (e.g., including evil twins, session hijacking, over shoulder, or other tricks). It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for biometric authentication-based access to displayed documents or content with modifiable frequency or schedule for triggering authentication processes. In examples, a computing system (or an authentication system of the computing system) receives a plurality of data including at least one of location data indicating a current location of the computing system, user access level data indicating an access level of a first user accessing one or more documents on the computing system, or document security level data indicating a security level for each document among the one or more documents being accessed. The computing system (or the authentication system) determines a security risk level for display of the one or more documents on a display screen of the computing system while the computing system is located within the current location, based on a combination of data among the plurality of data. The computing system (or the authentication system) sets or modifies at least one of a frequency or a schedule for triggering an authentication verification process, based on the security risk level for display of the one or more documents. In some examples, the authentication verification process, when triggered, includes capturing one or more images using a camera of the computing system; and determining whether any individuals, other than the first user, are within a viewing range of the display screen, based on analysis of the one or more images. Based on a determination that one or more individuals are within the viewing range of the display screen, the authentication verification process includes determining whether the one or more individuals are authorized to view the one or more documents that are being displayed or being accessed for display on the display screen. Based on a determination that at least one individual among the one or more individuals is not authorized to view the one or more documents being displayed on the display screen, the authentication verification process further includes performing one or more actions.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing biometric authentication-based access to displayed documents or content with modifiable frequency or schedule for triggering authentication processes.

FIGS. 2A and 2B depict an example sequence flow for implementing biometric authentication-based access to displayed documents or content with modifiable frequency or schedule for triggering authentication processes.

FIGS. 3A and 3B depict an example method for implementing biometric authentication-based access to displayed documents or content with modifiable frequency or schedule for triggering authentication processes.

FIGS. 4A and 4B depict another example method for implementing biometric authentication-based access to displayed documents or content with modifiable frequency or schedule for triggering authentication processes.

FIGS. 5A and 5B depict yet another example method for implementing biometric authentication-based access to displayed documents or content with modifiable frequency or schedule for triggering authentication processes.

FIG. 6 depicts a block diagram illustrating example physical components of a computing device with which aspects of the technology may be practiced.

### DETAILED DESCRIPTION OF CERTAIN EMBODIMENTS

As briefly discussed above, with users comfortable with working everywhere, like airports, coffee shops, restaurants, etc., attackers are using various tricks and tactics in obtaining sensitive information from devices of such users (e.g., including evil twins, session hijacking, over shoulder, or other tricks). When data is leaked, the implications can be massive, for an individual or millions of users of an online product or service, from financial loss to reputational damage, or any number of outcomes ranging between those severe possibilities.

The present technology provides for biometric authentication-based access to displayed documents or content with modifiable frequency or schedule for triggering authentication processes. The present technology utilizes real-time threat intelligence, drawing from factors including the current location of the computing system, the network the computing system is connected to, and other relevant contextual information, to enable the authentication system of the computing system to dynamically adjust the frequency and intensity of its authentication verification process checks. By taking all of these factors into account, the system can strike a balance that enhances security without placing an undue burden on system resources or disproportionately impacting the user experience.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

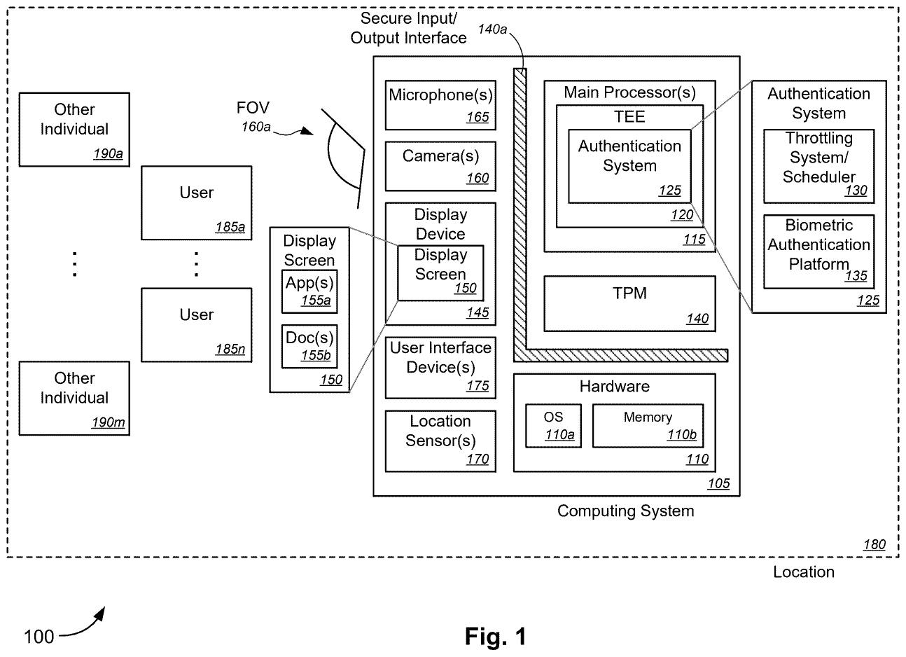

Turning to the embodiments as illustrated by the drawings, FIG. 1-5 illustrate some of the features of methods, systems, and apparatuses for implementing biometric authentication-based access to displayed documents or content with modifiable frequency or schedule for triggering authentication processes, as referred to above. The methods, systems, and apparatuses illustrated by FIG. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

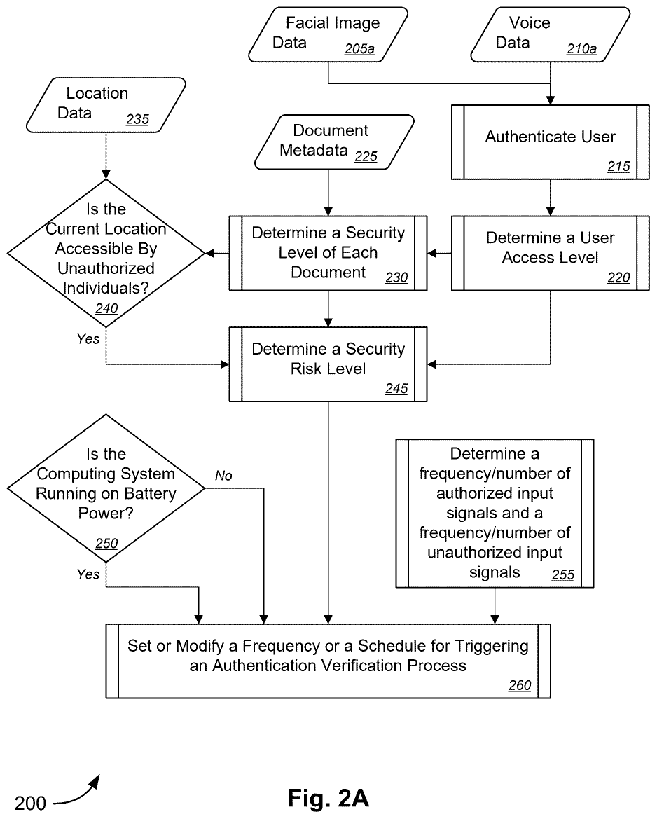

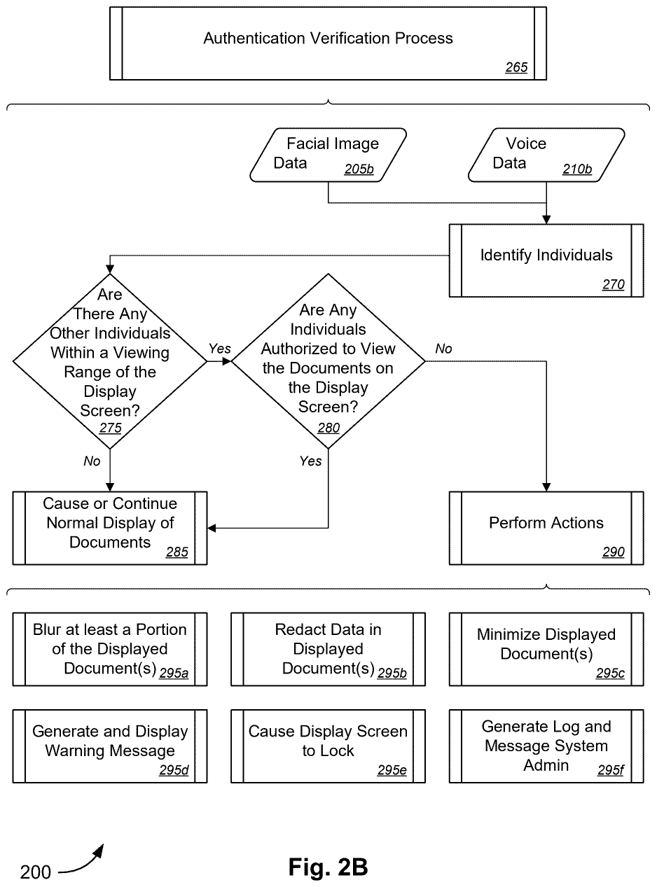

FIG. 1 depicts an example system 100 for implementing biometric authentication-based access to displayed documents or content with modifiable frequency or schedule for triggering authentication processes. System 100 includes a computing system 105, which includes hardware components 110 including an operating system (“OS”) 110a and memory 110b. In examples, the computing system 105 further includes a main processor(s) 115, a trusted execution environment (“TEE”) 120 established on the main processor(s) 115, and an authentication system 125 hosted within the TEE 120. The TEE 120 is a secure or protected area of the main processor(s) 115 that keeps data and code secure and isolated from the rest of the computing system 105 (e.g., the OS 110 and other software applications), thereby preventing the OS 110 and other software applications from accessing, replacing, or modifying the data and code within the TEE 120. In some examples, the authentication system 125 includes a throttling system or scheduler 130 and a biometric authentication platform 135. In some cases, the throttling system or scheduler 130 sets or modifies a frequency (or a schedule) for triggering an authentication verification process, which is described in detail below with respect to FIGS. 2B, 3B, and 4B. The computing system further includes a trusted platform module (“TPM”) 140, which is a cryptographic processor or cryptoprocessor that generates and stores cryptographic keys that are used to encrypt data and decrypt encrypted data. In examples, the biometric authentication platform 135 stores within the TEE 120 cryptographic hashes of biometric data (e.g., facial images, voice signals, fingerprints, and/or other biometrics) of authorized individuals, and authenticates users by applying a cryptographic hash function (in some cases, using one or more cryptographic keys that are generated and/or stored in the TPM 140) on currently received biometric data (e.g., facial image data and/or voice data), and comparing the cryptographically hashed currently received biometric data to the locally stored cryptographic hashes of the biometric data of known users. A user is authenticated if the cryptographically hashed currently received biometric data matches one or more of the locally stored cryptographic hashes of the biometric data of known users, and fails authentication if the cryptographically hashed currently received biometric data fails to match any of the locally stored cryptographic hashes of the biometric data of known users. In examples, the TEE 120 and/or the TPM 140 prevent, using a secure input/output interface 140a certain sensitive information (e.g., biometric data or other privacy-related information associated with users), in their raw form (or readable form) from being accessed or transferred to non-secure portions of the computing system 105, at least without first cryptographically hashing such sensitive information.

In some examples, the computing system 105 further includes a display device 145 having a display screen 150, on which may be displayed one or more software applications (“apps”) 155a and/or one or more documents 155b (collectively, “documents 155”). In examples, the one or more apps 155a and/or the one or more documents 155b contain at least one of textual, numerical, or diagrammatic information, at least some of which includes sensitive information. In some instances, the sensitive information includes at least one of personally identifiable information (“PII”), financial information, proprietary information, secret information, national security information, military information, non-child-friendly content, or exam responses. In some cases, PII includes directly identifying information, indirectly identifying information, and other information. In some examples, the directly identifying information includes social security number (“SSN”), passport number, driver's license number, taxpayer identification number, patient identification number, financial account number, credit card number, personal address, email address, telephone number, and/or biometric information (e.g., facial biometric data, retinal biometric data, fingerprint data, handprint data, voice data, or other biometric data). In some instances, the indirectly identifying information includes gender, race, birth date, place of birth, and/or geographic indicator. In some cases, other information includes medical, educational, financial, and/or employment information.

Computing system 105 further includes one or more cameras 160, one or more microphones 165, one or more location sensors 170, and one or more user interface devices 175. The computing system 105 is located within a location 180 (referred to herein as “current location”). The one or more cameras 160—which may be integrated within a housing of the computing system 105 or may be external, yet communicatively coupled, to the computing system 105—capture images (including facial images of individuals who are present, including one or more of users 185a-185n and/or one or more of other individuals 190a-190m) within its field of view (“FOV”) 160a, which is configured or set to be directed to a space in front of or within view of the display screen 150. As used herein, users refer to known individuals (e.g., individuals whose biometric information or a cryptographically hashed version is stored in the TEE 120 of the computing system 105), while other individuals refer to unknown or not yet verified individuals. Herein, m and n are non-negative integer numbers that may be either all the same as each other, all different from each other, or some combination of same and different (e.g., one set of two or more having the same values with the others having different values, a plurality of sets of two or more having the same value with the others having different values). The one or more microphones 165—which may be integrated within the housing of the computing system 105 or may be external, yet communicatively coupled, to the computing system 105—captures audio signals (including voice data of individuals who are present) within an area around the computing system 105. In some examples, the one or more user interface devices 175—which may be integrated within a housing of the computing system 105 or may be external, yet communicatively coupled, to the computing system 105—include a keyboard, a mouse, a joystick, a touchpad, a number pad, a touchscreen display, and/or other wirelessly connected or wired peripheral devices.

In examples, the one or more location sensors 170 include at least one of a global navigation satellite system (“GNSS”)-based location sensor (e.g., a Global Positioning System (“GPS”)-based sensor, a Global Navigation Satellite System (“GLONASS”)-based sensor, or other satellite-based sensor), a wireless access point (“WAP”)-based positioning system (“WAPPS”)-based location sensor (e.g., a Wi-Fi access point-based location sensor), or a cellular positioning system (“CPS”)-based location sensor. In some cases, GNSS-based location data is used to indicate a location that is correlated with geographical coordinates, which can be correlated with publicly accessible information (e.g., addresses, building names, or other identifiers of locations). Similarly, WAPPS-based location data can provide networks (e.g., Wi-Fi networks) that are within wireless range of the computing system, with the networks indicating public or secure access. Proximity to such Wi-Fi networks, especially correlated with signal strength of two or more Wi-Fi networks as detected by the WAPPS-based location data, can be used to determine a position or location, particularly when the locations of the Wi-Fi access points are known. Likewise, CPS-based location data can be used to triangulate a location, and, like the GNSS-based location data, correlated with geographical coordinates and with publicly accessible information (e.g., addresses, building names, or other identifiers of locations).

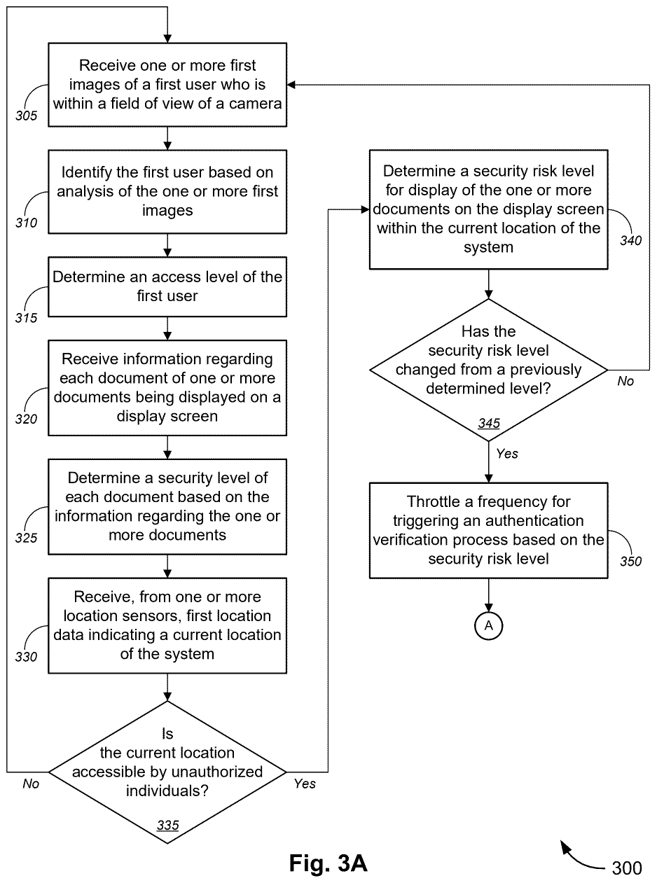

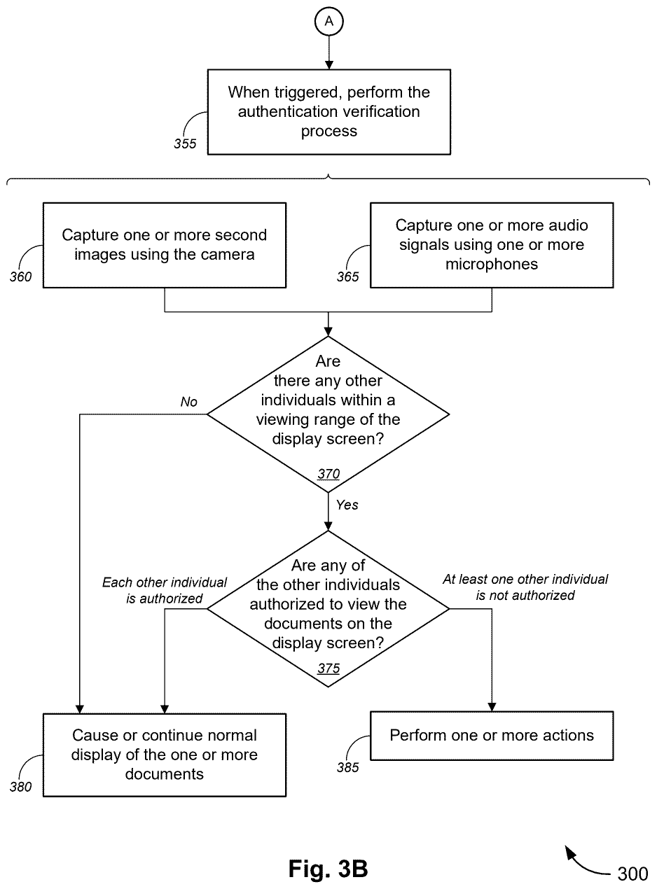

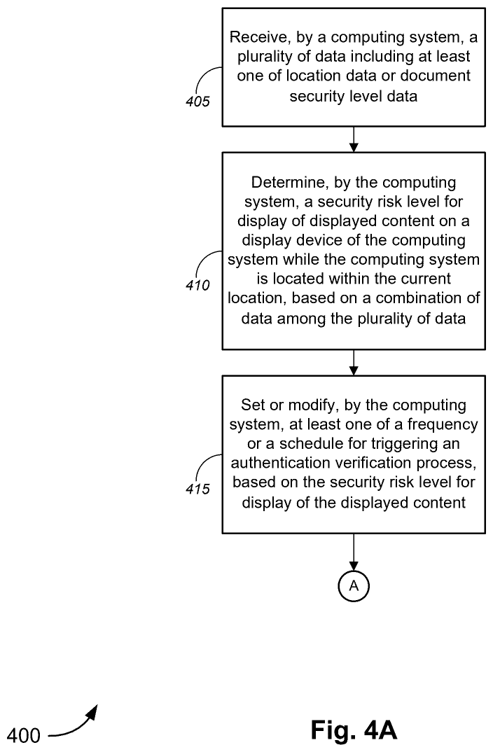

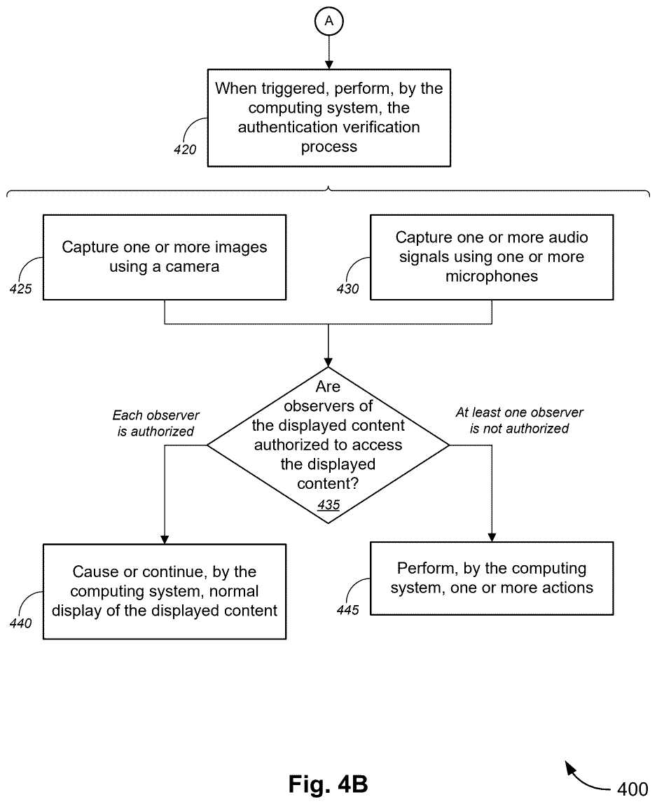

In operation, the computing system 105 and/or authentication system 125 of the computing system 105 may perform methods for implementing biometric authentication-based access to displayed documents or content with modifiable frequency or schedule for triggering authentication processes, as described in detail with respect to FIGS. 2A-4B. For example, example sequence flow 200 as described below with respect to FIGS. 2A and 2B, and methods 300 and 400 as described below with respect to FIGS. 3A-3B and 4A-4B, respectively, may be applied with respect to the operations of system 100 of FIG. 1.

FIGS. 2A and 2B depict an example sequence flow 200 for implementing biometric authentication-based access to displayed documents or content with modifiable frequency or schedule for triggering authentication processes.

With reference to example sequence flow 200 of FIG. 2A, a computing system (e.g., computing system 105 of FIG. 1) or components thereof (e.g., authentication system 125 of computing system 105 of FIG. 1) receives facial image data 205a and, in some cases, voice data 210a as well. In examples, the facial image data 205a includes image data of a first user among a plurality of users (e.g., user 185a among users 185a-185n of FIG. 1) taken within a FOV of a camera (e.g., FOV 160a of camera 160 of FIG. 1) of the computing system, where the FOV covers a space in front of a display screen of a display device (e.g., display screen 150 of display device 145 of FIG. 1) of the computing system. In some examples, the voice data includes voice data of the first user that is recorded by one or more microphones (e.g., microphone(s) 165 of FIG. 1) of the computing system, the microphones recording sounds in an area around the computing system. At operation 215, the computing system (or authentication system) authenticates a first user among a plurality of users, based on at least one of the facial image data 205a and/or the voice data 210a, in some cases, using a biometric authentication platform (e.g., biometric authentication platform 135 of FIG. 1). In some examples, the biometric authentication platform stores within a secure portion of the computing system (e.g., within a TEE) cryptographic hashes of biometric data (e.g., facial images, voice signals, fingerprints, and/or other biometrics) of authorized individuals, and authenticates users by applying a cryptographic hash on currently received biometric data (e.g., facial image data 205a and/or voice data 210a), and comparing the cryptographically hashed currently received biometric data to the locally stored cryptographic hashes of biometric data. The first user is authenticated if the cryptographically hashed currently received biometric data matches one or more of the locally stored cryptographic hashes of biometric data, and fails authentication if the cryptographically hashed currently received biometric data fails to match any of the locally stored cryptographic hashes of biometric data.

After the first user is authenticated (at operation 215), the computing system (or the authentication system) determines a user access level for the first user (at operation 220). For example, a high-level individual within an organization would have access to highly sensitive information, and thus such individuals would have a high user access level. A medium-level individual within an organization would have access to sensitive information (but not typically highly sensitive information), and thus such individuals would have a medium user access level. A low-level individual within an organization would have limited access to any sensitive information, and thus such individuals would have a low user access level. Examples of high-level individuals include individuals running a company (e.g., a chief executive officer (“CEO”), a chief financial officer (“CFO”), a president, a vice president, other officer, or a board member of a company), a military commanding officer (e.g., a general, an admiral, a lieutenant general, a vice admiral, a major general, a rear admiral, or other similar ranks above a captain rank), or a government official of a national, state/provincial, or municipal government (e.g., a President or Prime Minister, a Vice President, a cabinet member, a member of a Congress or Legislature, a Governor or Premier, a Mayor, or other similar political rank). Examples of medium-level individuals include middle managers within a company, a mid-rank military officer (e.g., a lieutenant or a captain), or an aide or staff to a government official. Examples of low-level individuals include regular employees or contractors within a company, a military non-commissioned officer or enlisted personnel, or secretaries or clerks of a government official.

In examples, the computing system (or the authentication system) receives document metadata 225 for one or more documents being accessed for display or being displayed within the display screen of the display device. In examples, the document metadata 225 for each document among the one or more documents includes at least one of first metadata indicating a level of sensitive information contained within that document, second metadata indicating which fields within that document contain sensitive information, or third metadata indicating which portions of that document contain sensitive information. In some instances, the sensitive information includes at least one of PII, financial information, proprietary information, secret information, national security information, military information, non-child-friendly content, or exam responses. At operation 230, the computing system (or the authentication system) determines a security level of each document, based on the document metadata 225 (e.g., based on the at least one of the first metadata, the second metadata, or the third metadata). In some examples, determining the security level of each document is further based on the user access level of the first user accessing (or having access to) the one or more documents being accessed for display or being displayed within the display screen of the display device (as denoted by the arrow from operation 220 to operation 230).

In some examples, the computing system (or the authentication system) receives location data 235, and determines whether a current location (which is determined based on the location data 205) is accessible by unauthorized individuals. In examples, the location data 235 includes at least one of GNSS-based location data, WAPPS-based location data, or CPS-based location data. In examples, determining whether the current location is accessible by unauthorized individuals is based on GNSS-based location data indicating a location that is correlated with geographical coordinates. The geographical coordinates can be correlated with publicly accessible information (e.g., addresses, building names, or other identifiers of locations) and used as a basis for determining accessibility by members of the general public or by restricted personnel. Similarly, WAPPS-based location data can provide networks that are within wireless range of the computing system, with the networks indicating public or secure access, and can be used as a basis for determining accessibility by members of the general public or by restricted personnel. Likewise, CPS-based location data can be used to triangulate a location, and, like the GNSS-based location data, correlated with geographical coordinates and with publicly accessible information (e.g., addresses, building names, or other identifiers of locations), and used as a basis for determining accessibility by members of the general public or by restricted personnel. In some examples, determining what constitutes an unauthorized individual is based on the security level of each document being accessed for display or being displayed within the display screen of the display device (as denoted by the arrow from operation 230 to operation 240), and such determination is used (in conjunction with the location data 235) to determine whether the current location is accessible by unauthorized individuals.

At operation 245, the computing system (or the authentication system) determines a security risk level for display of the one or more documents on the display screen within the current location of the system, based on a combination of the access level of the first user (from operation 220), the security level of each document (from operation 230), and whether the current location of system is accessible by unauthorized individuals (from operation 240). At operation 250, the computing system (or the authentication system) determines whether the computing system is running on battery power or plugged into an electrical outlet. At operation 255, the computing system (or the authentication system) determines a frequency and/or a number of authenticated input signals and a frequency and/or a number of unauthenticated input signals. In examples, authenticated input signals include biometric authentication input signals (e.g., face biometric authenticated input signal, fingerprint biometric authenticated input signal, or other biometric authenticated input signal). In some cases, unauthenticated input signals include input signals from non-biometric-based interface devices including a keyboard, a mouse, a wireless peripheral device, or other peripheral device.

At operation 260, the computing system (or the authentication system) sets or modifies at least one of a frequency or a schedule for triggering an authentication verification process. In some cases, setting or modifying the at least one of the frequency or the schedule for triggering the authentication verification process is based at least in part on the security risk level for display of the one or more document (from operation 245). That is, the higher the security risk level, the higher the frequency (and corresponding frequent schedule(s)) for triggering the authentication verification process. For instance, for a high security risk level, a higher frequency (e.g., every 30 seconds, every minute, every other minute, every 5 or 10 minutes, or similar interval) is set for triggering the authentication verification process or a schedule is set corresponding to the higher frequency. In a high security risk level situation, the authentication system may also flag any unusual behavior more aggressively, and although it could result in some false positives, this high level of scrutiny is necessary to safeguard confidential information. For a low security risk level, a lower frequency (e.g., every hour, or every other hour, or similar interval) is set for triggering the authentication verification process or a schedule is set corresponding to the lower frequency. For a medium security risk level, a medium frequency (e.g., every 20 minutes, every 30 minutes, every 40 minutes, or similar interval) is set for triggering the authentication verification process or a schedule is set corresponding to the medium frequency.

Alternatively, or additionally, setting or modifying the at least one of the frequency or the schedule for triggering the authentication verification process is based at least in part on the frequency of authenticated input signals, the frequency of unauthenticated input signals, the number of authenticated input signals within a set period, or the number of unauthenticated input signals within the set period (from operation 255). That is, where the number or frequency of unauthenticated input signals exceeds the number or frequency of authenticated input signals, or where a distribution or ratio of unauthenticated input signals to authenticated input signals exceeds a first threshold value (e.g., 30, 40, 50, 60, 70, 80, or 90 percent (%)) or where a distribution or ratio of authenticated input signals to unauthenticated input signals falls below a second threshold value (e.g., 50, 40, 30, 20, or 10 %), then the frequency (and corresponding frequent schedule(s)) for triggering the authentication verification process is increased, and vice versa. In still other cases, setting or modifying the at least one of the frequency or the schedule for triggering the authentication verification process is based at least in part on whether the computing system is running on battery power or plugged into an electrical outlet (from operation 250). That is, in the case that the computing system is running on battery power, the frequency (and corresponding frequent schedule) for triggering the authentication verification process is moderated according to the remaining battery power and expected usage while under battery power, even for high security risk levels and higher relative frequency/number/ratio of unauthorized input signals versus authorized input signals. In the case that the computing system is running on power from the electrical outlet, triggering the authentication verification process is based at least in part on the security risk level and/or the relative frequency/number/ratio of unauthorized input signals versus authorized input signals. Although unauthorized input signals are assigned a lower trust level compared with authorized input signals, mitigating factors can be used to improve the trust level of the unauthorized input signals. For example, mitigating factors include enabling operating system functionalities like secure boot, implementing application control policy, and/or utilizing hypervisor-based code integrity.

Because the authentication verification process requires turning the camera on and processing the captured images, electrical power is required to be drawn. If the computing system is plugged into an electrical outlet, there is a constant supply of electrical power and it matters not the power draw for the authentication verification process, even if at the higher frequency. On the other hand, if the computing system is running on battery power, a balance must be struck between power draw and security provided by the higher frequency triggering of the authentication verification process. For instance, each full cycle of authentication by the authentication verification process may result in about a 0.5 % additional battery usage, while flagging of any unusual behavior may result in up to about 2.5 % increase in battery usage. In some cases, thresholds of battery power can be used for the triggering frequency. For example, for a battery level greater than 70 %, higher frequency triggering may be implemented if a high security risk level is determined. For a battery level between 30 % and 70 %, for instance, medium frequency triggering may be implemented even if a high security risk level is determined. For a battery level less than 30 %, for example, low frequency triggering may be implemented even if a high security risk level is determined. In the latter two cases, warning messages may be displayed to warn the first user as to the security risks with the lower frequency triggerings, especially if a high security risk level is determined, and/or to warn the first user to plug the computing system into an electrical outlet.

In some examples, the input signals (whether authenticated or unauthenticated) along with any signals from the TEE and/or TPM (e.g., TEE 120 and/or TPM 140 of FIG. 1) are logged for audit purposes, and are locally retained and collected centrally for purposes including forensic analysis using log forwarding and management systems.

Referring to FIG. 2B, the authentication verification process 265, when triggered, includes the computing system receiving one or more facial image data 205b and, in some cases, voice data 210b as well. In examples, the facial image data 205b includes image data of individuals within the FOV of the camera at the time the camera is activated in response to triggering of the authentication verification process 265, where such individuals may include one or more of the plurality of users (e.g., the plurality of users 185a-185n of FIG. 1) and/or one or more other individuals (e.g., other individuals 190a-190m of FIG. 1). In some examples, the voice data includes voice data, which is recorded by the one or more microphones, of any individuals in an area around the computing system at the time the one or more microphones are activated in response to triggering of the authentication verification process 265. At operation 270, the computing system (or the authentication system) identifies individuals based on analysis of the facial image data 205b and/or the voice data 210b.

At operation 275, the computing system (or the authentication system) determines whether any other individuals (e.g., other individuals 190a-190m, who are separate from known users 185a-185n of FIG. 1) are within a viewing range of the display screen, based on the identified individuals (from operation 270). Based on a determination that no other individuals are within the viewing range of the display screen, sequence flow 200 continues onto the process at operation 285. Based on a determination that one or more other individuals are within the viewing range of the display screen, the computing system (or the authentication system) determines whether the one or more other individuals are authorized to view the one or more documents being displayed on the display screen (at operation 280). In some instances, determining whether the one or more other individuals are authorized to view the one or more document (at operation 280) is performed based on facial biometric authentication of a face of each of the one or more individuals, based on analysis of the facial image data 205b. Based on a determination that each other individual is authorized to view the one or more documents being displayed, sequence flow 200 continues onto the process at operation 285. Based on a determination that at least one other individual among the one or more other individuals is not authorized to view the one or more documents being displayed on the display screen, sequence flow 200 continues onto the process at operation 290.

At operation 285, the computing system (or the authentication system) causes or continues normal (e.g., unmodified) display of the one or more documents on the display screen. At operation 290, the computing system (or the authentication system) performs one or more actions. In an example, the one or more actions include, for each document, among the one or more documents, having a security level that exceeds a non-public security threshold level, the computing system (or the authentication system) causing one of: (a) blurring of at least a portion of that document being displayed on the display screen (at operation 295a); (b) redaction of data (e.g., at least one of textual, numerical, or diagrammatic information) contained and displayed within that document (at operation 295b); or (c) minimization of that document within the display screen (at operation 295c). In another example, the one or more actions include the authentication system causing the computing system to generate, and display on the display screen, (or the computing system generating and displaying) a message to the first user indicating presence of individuals within view of the one or more documents being displayed on the display screen and warning whether the first user would still want to proceed with displaying the one or more documents while the computing system is within the current location (at operation 295d). In yet another example, the one or more actions include the authentication causing the computing system to initiate (or the computing system initiating) a screen lock on the display screen (at operation 295e). In still another example, the one or more actions include the computing system (or the authentication system) generating, and sending, a log to a system administrator (at operation 295f). In examples, the log indicates at least one of instances where presence of individuals within view of the one or more documents being displayed or being accessed for display on the display screen was detected, the at least one of the frequency or the schedule for triggering the authentication verification process, or instances that actions were performed in response to the authentication verification process being performed.

In examples, the one or more actions cause the display of the one or more documents on the display screen to change from an unmodified state to a modified state. In some examples, the authentication verification process 265 further includes, based on a determination that there are no unauthorized individuals within the viewing range of the display screen, the computing system (or the authentication system) performing one of continuing the display of the one or more documents in an unmodified state or causing the display of the one or more documents to return from the modified state to the unmodified state. In some cases, the authentication verification process 265 is further triggered by at least one of a user-initiated trigger, detection of motion of at least one individual away from the system, elapsing of a first count-down timer that is started after a latest triggering of the authentication verification process, or elapsing of a second count-down timer that is started after cessation of motion in front of the display screen.

Referring to FIGS. 1, 2A, and 2B, the present technology is applicable to various situations that benefit from biometric authentication-based access to displayed documents or content with modifiable frequency or schedule for triggering authentication processes. In an example, Mr. May, the head of military routes for the army, has had his laptop access physically compromised and an attacker has access to the unlocked laptop. In such situations, the attacker would typically be able to gain access to information on the routes of military officers and assets, which, if compromised, can have a huge impact on national security. However, with the present technology, gaining access to the system would not automatically allow access to some documents that have been tagged to be extremely confidential, such document or content (e.g., file(s)) would only be accessible to the owners of the file(s), based on the authentication verification process (and the process for setting or modifying trigger frequency or schedule; as described in detail herein). For instance, in a situation where the attacker has access to such a file(s) that have been opened, the authentication verification process, when triggered, would cause the file(s) to close immediately when it determines that the person in front of the display screen either is not the assigned owner/user of the laptop or is not otherwise authorized to view the file(s).

In another example, Mr. June has spent the whole night working on a trade secret project, but could not complete it on time. Mr. June is on his way to Redmond, Washington, from Washington, D.C., to present his project to the board. He had planned to get to Redmond before 10 a.m. and to finish the project ahead of his presentation by 4 p.m. Unfortunately, the news came that his flight has been delayed and he will not arrive in Redmond until 3 p.m. Mr. June would not be able to complete his project after arriving in Redmond and before the presentation, so he decided to open his laptop at the airport to work. He was in the mood to get the work done, without paying full attention to the environment. An attacker somehow peeks at the display screen from over his shoulder and would be able to view enough content such as to cause significant damage to the business. With the authentication verification process (and the process for setting or modifying trigger frequency or schedule), when users are working on documents of such nature, the authentication system continues to scan for any eyes looking directly at (or for the presence of unauthorized individuals, like the attacker, within viewing range of) the display screen. When such situations are detected, the authentication system warns the authorized user(s) (in this case, Mr. June) to be extremely watchful and to be careful of other people in the environment. The authentication system utilizes the location as a factor and when it is noticed that the users are in an unsecure area (like the airport, coffee shops, marketplaces, etc.), the authentication system automatically closes out the documents (or locks the laptop itself) after many warnings as set by a system administrator for such documents or such devices.

In yet another example, the authentication verification process (and the process for setting or modifying trigger frequency or schedule) may be used for exam purposes. Most Universities and other educational institutions are now carrying out examinations and other assessments online. In some examples, a test-taker would be an authorized user, while other individuals are not authorized. In such cases, the authentication verification process (and the process for setting or modifying trigger frequency or schedule) sets a high frequency authentication verification check. When other individuals are detected either looking at the display screen of the test-taker's computing system or in range of view of the display screen, the triggered authentication verification process causes either blurring of exam responses, redaction of exam responses, or minimization of an exam response window.

In still another example, the authentication verification process (and the process for setting or modifying trigger frequency or schedule) may be used for parental control purposes. In contemporary or modern television programs, movies, videos, multimedia streams, text messages, multimedia messages, or similar media content, non-child-appropriate content may be present or ubiquitous. The process for setting or modifying trigger frequency or schedule may determine likelihood of the presence of children in the area (and more specifically within viewing range of the display screen) of the media playback device (e.g., smart phone, tablet computer, laptop computer, television, or desktop computer). Based on this likelihood, the frequency or schedule for triggering the authentication verification process can be set or modified, in accordance to the manner described herein. When triggered, the authentication verification process detects presence of children within viewing range of the display screen, and causes either blurring of any non-child-appropriate content, redaction of any non-child-appropriate content, or minimization of windows or apps displaying any non-child-appropriate content.

FIGS. 3A and 3B depict an example method 300 for implementing biometric authentication-based access to displayed documents or content with modifiable frequency or schedule for triggering authentication processes. With reference to FIGS. 3A and 3B, the operations of example method 300 may be performed by a computing system (e.g., computing system 105 of FIG. 1) and/or components thereof (e.g., authentication system 125 of FIG. 1). In some examples, the authentication system is hosted within a TEE in a main processor (e.g., TEE 120 in main processor(s) 115 of FIG. 1) of the computing system. Method 300 of FIG. 3A continues onto FIG. 3B following the circular marker denoted, “A.”

In the example method 300 of FIG. 3, at operation 305, a computing system (or an authentication system of the computing system) receives one or more first images of a first user (e.g., user 185a of FIG. 1) who is within a field of view of a camera (e.g., FOV 160a of camera(s) 160 of FIG. 1). The computing system (or the authentication system) identifies the first user based on analysis of the one or more first images (at operation 310). In some cases, identifying the first user (at operation 310) is performed based on facial biometric authentication of a face of the first user. At operation 315, the computing system (or the authentication system) determines an access level of the first user.

At operation 320, the computing system (or the authentication system) receives information regarding each document of one or more documents (e.g., documents 155 of FIG. 1) being displayed on a display screen (e.g., display screen 150 of display device 145 of FIG. 1). In some examples, the information regarding each document being displayed on the display screen includes at least one of first metadata indicating a level of sensitive information contained within that document, second metadata indicating which fields within that document contain sensitive information, or third metadata indicating which portions of that document contain sensitive information. In examples, the sensitive information includes at least one of PII, financial information, proprietary information, secret information, national security information, military information, non-child-friendly content, or exam responses. The computing system (or the authentication system) determines a security level of each document based on the information regarding the one or more documents (at operation 325), in some cases, based on the at least one of the first metadata, the second metadata, or the third metadata.

At operation 330, the computing system (or the authentication system) receives, from one or more location sensors (e.g., location sensor(s) 170 of FIG. 1), first location data indicating a current location (e.g., location 180 of FIG. 1) of the system. In some examples, the one or more location sensors include at least one of a GNSS-based location sensor, a WAPPS-based location sensor, or a CPS-based location sensor. At operation 335, the computing system (or the authentication system) determines whether the current location of the computing system is accessible by unauthorized individuals. Based on a determination that the current location of the computing system is not accessible by unauthorized individuals, method 300 returns to the process at operation 305, and the processes at operations 305-335 are repeated for the next set of one or more first images, the next set of one or more documents, and/or the next current location of the computing system. Based on a determination that the current location of the computing system is accessible by unauthorized individuals, method 300 continues onto the process at operation 340.

At operation 340, the computing system (or the authentication system) determines a security risk level for display of the one or more documents on the display screen while the computing system is within the current location of the system, based on a combination of the access level of the first user, the security level of each document, and whether the current location of system is accessible by unauthorized individuals. At operation 345, the computing system (or the authentication system) determines whether the security risk level has changed from a previously (e.g., the last or immediately preceding) determined security risk level. Based on a determination that the security risk level has not changed from a previously determined security risk level, method 300 returns to the process at operation 305. Based on a determination that the security risk level has changed from a previously determined security risk level, the computing system (or the authentication system) throttles a frequency for triggering an authentication verification process based on the security risk level (at operation 350). In some cases, the frequency for triggering the authentication verification process is set or determined based on a plurality of factors including the security risk level for display of the one or more documents, whether the computing system is running on battery power or plugged into an electrical outlet, a frequency of authenticated input signals, a frequency of unauthenticated input signals, a number of authenticated input signals within a set period, or a number of unauthenticated input signals within the set period. In some instances, throttling the frequency (e.g., using throttling system or scheduler 130 of FIG. 1) for triggering the authentication verification process includes one of increasing the frequency, decreasing the frequency, or changing a schedule for triggering the authentication verification process. Method 300 continues onto the process at operation 355 following the circular marker denoted, “A.”

With reference to FIG. 3B, at operation 355 (following the circular marker denoted, “A,” in FIG. 3A), method 300 includes the computing system (or the authentication system) performing the authentication verification process, when triggered. In examples, the authentication verification process includes: the computing system capturing one or more second images using the camera (at operation 360); and the computing system captures one or more audio signals using one or more microphones (e.g., microphone(s) 165 of FIG. 1) (at operation 365). At operation 370, the computing system (or the authentication system) determines whether any individuals, other than the first user, are within a viewing range of the display screen, based on analysis of the one or more second images and/or analysis of the one or more audio signals. Based on a determination that no other individuals are within the viewing range of the display screen, method 300 continues onto the process at operation 380. Based on a determination that one or more other individuals are within the viewing range of the display screen, the computing system (or the authentication system) determines whether the one or more other individuals are authorized to view the one or more documents being displayed on the display screen (at operation 375). In some instances, determining whether the one or more other individuals are authorized to view the one or more document (at operation 375) is performed based on facial biometric authentication of a face of each of the one or more individuals. Based on a determination that each other individual is authorized to view the one or more documents being displayed, method 300 continues onto the process at operation 380. Based on a determination that at least one other individual among the one or more other individuals is not authorized to view the one or more documents being displayed on the display screen, method 300 continues onto the process at operation 385.

At operation 380, the computing system (or the authentication system) causes or continues normal (e.g., unmodified) display of the one or more documents on the display screen. At operation 385, the computing system (or the authentication system) performs one or more actions. In an example, the one or more actions include, for each document among the one or more documents, having a security level that exceeds a non-public security threshold level, the computing system causing one of: (a) blurring of at least a portion of that document being displayed on the display screen; (b) redaction of at least one of textual, numerical, or diagrammatic information contained and displayed within that document; or (c) minimization of that document within the display screen. In another example, the one or more actions include the authentication system causing the computing system to generate, and display on the display screen, (or the computing system generating and displaying) a message to the first user indicating presence of individuals within view of the one or more documents being displayed on the display screen and warning whether the first user would still want to proceed with displaying the one or more documents while the computing system is within the current location. In yet another example, the one or more actions include the authentication causing the computing system to initiate (or the computing system initiating) a screen lock on the display screen. In still another example, the one or more actions include the computing system (or the authentication system) generating, and sending to a system administrator, a log indicating at least one of instances where presence of individuals within view of the one or more documents being displayed on the display screen was detected, the frequency for triggering the authentication verification process, or instances that actions were performed in response to the authentication verification process being performed.

In examples, the one or more actions cause the display of the one or more documents on the display screen to change from an unmodified state to a modified state. In some examples, the authentication verification process further includes, based on a determination that there are no unauthorized individuals within the viewing range of the display screen, the computing system (or the authentication system) performing one of continuing the display of the one or more documents in an unmodified state or causing the display of the one or more documents to return from the modified state to the unmodified state. In some cases, the authentication verification process is further triggered by at least one of a user-initiated trigger, detection of motion of at least one individual away from the system, elapsing of a first count-down timer that is started after a latest triggering of the authentication verification process, or elapsing of a second count-down timer that is started after cessation of motion in front of the display screen.

FIGS. 4A and 4B depict another example method 400 for implementing biometric authentication-based access to displayed documents or content with modifiable frequency or schedule for triggering authentication processes. With reference to FIGS. 4A and 4B, the operations of example method 400 may be performed by a computing system (e.g., computing system 105 of FIG. 1) and/or components thereof (e.g., authentication system 125 of FIG. 1). Method 400 of FIG. 4A continues onto FIG. 4B following the circular marker denoted, “A.”

In the example method 400 of FIG. 4, at operation 405, a computing system (or the authentication system) receives a plurality of data including at least one of location data indicating a current location (e.g., location 180 of FIG. 1) of the computing system or document security level data indicating a security risk level for each document among displayed content being accessed. In examples, the location data includes at least one of GNSS-based location data, WAPPS-based location data, or CPS-based location data.

At operation 410, the computing system (or the authentication system) determines a security risk level for display of the displayed content (e.g., documents 155 of FIG. 1) on a display device (e.g., display screen 150 of display device 145 of FIG. 1) of the computing system while the computing system is located within the current location, based on a combination of data among the plurality of data. At operation 415, the computing system (or the authentication system) sets or modifies at least one of a frequency or a schedule for triggering an authentication verification process, based on the security risk level for display of the displayed content. In some cases, setting or modifying the at least one of the frequency or the schedule for triggering the authentication verification process is further based at least in part on one or more of a frequency of authorized input signals, a frequency of unauthorized input signals, a number of authenticated input signals within a set period, or a number of unauthenticated input signals within the set period, and/or whether the computing system is running on battery power or plugged into an electrical outlet. Method 400 continues onto the process at operation 420 following the circular marker denoted, “A.”

With reference to FIG. 4B, at operation 420 (following the circular marker denoted, “A,” in FIG. 4A), method 400 includes the computing system (or the authentication system) performing the authentication verification process, when triggered. In examples, the authentication verification process includes: the computing system capturing one or more images using a camera (e.g., camera(s) 160 of FIG. 1) (at operation 425); and, in some cases, the computing system capturing one or more audio signals using one or more microphones (e.g., microphone(s) 165 of FIG. 1) (at operation 430). At operation 435, the computing system (or the authentication system) determines whether observers of the displayed content are authorized to access the displayed content, in some cases, based on analysis of the one or more images and/or analysis of the one or more audio signals. In some instances, determining whether the observers of the displayed content are authorized to access the displayed content (at operation 435) is performed based on facial biometric authentication of a face of each observer. Based on a determination that each observer is authorized to access the displayed content being displayed on the display device, method 400 continues onto the process at operation 440. Based on a determination that at least one observer is not authorized to access the displayed content being displayed on the display device, method 400 continues onto the process at operation 445.

At operation 440, the computing system (or the authentication system) causes or continues normal (e.g., unmodified) display of the displayed content on the display device. At operation 450, the computing system (or the authentication system) performs one or more actions. In examples, the one or more actions include, for each document, among the displayed content, having a security level that exceeds a non-public security threshold level, that is being accessed for display on the display device, the computing system performing (or the authentication system causing the computing system to perform) blocking display of that document. Alternatively or additionally, the computing system performs (or the authentication system causing the computing system to perform) generating, and displaying on the display device, a message to the first user indicating presence of individuals within view of the displayed content being accessed for display on the display device and warning whether the first user would still want to proceed with accessing and displaying the displayed content within the current location.

In an example, the one or more actions include, for each document, among the displayed content, having a security level that exceeds a non-public security threshold level, the computing system causing one of: (a) blurring of at least a portion of that document being displayed on the display device; (b) redaction of at least one of textual, numerical, or diagrammatic information contained and displayed within that document; or (c) minimization of that document within the display device. In another example, the one or more actions include the authentication system causing the computing system to generate, and display on the display device, (or the computing system generating and displaying) a message to an authorized user among the observers indicating presence of observers within view of the displayed content being displayed on the display device and warning whether the authorized user would still want to proceed with displaying the displayed content while the computing system is within the current location. In yet another example, the one or more actions include the authentication causing the computing system to initiate (or the computing system initiating) a screen lock on the display device. In still another example, the one or more actions include the computing system (or the authentication system) generating, and sending to a system administrator, a log indicating at least one of instances where presence of observers within view of the displayed content being displayed or being accessed for display on the display device was detected, the at least one of the frequency or the schedule for triggering the authentication verification process, or instances that actions were performed in response to the authentication verification process being performed.

In examples, the one or more actions cause the display of the displayed content on the display device to change from an unmodified state to a modified state. In some examples, the authentication verification process further includes, based on a determination that there are no unauthorized observers within the viewing range of the display device, the computing system (or the authentication system) performing one of continuing the display of the displayed content in an unmodified state or causing the display of the displayed content to return from the modified state to the unmodified state. In some cases, the authentication verification process is further triggered by at least one of a user-initiated trigger, detection of motion of unauthorized observers away from the system, elapsing of a first count-down timer that is started after a latest triggering of the authentication verification process, or elapsing of a second count-down timer that is started after cessation of motion in front of the display device.

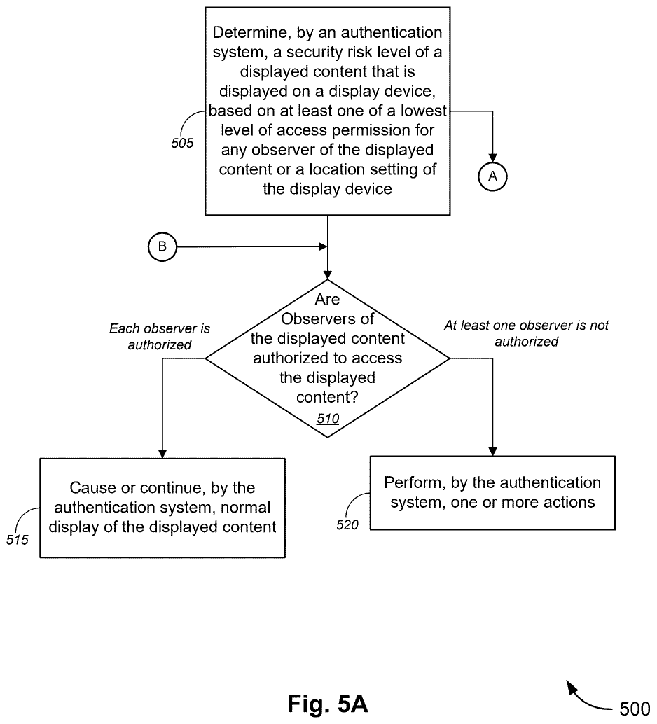

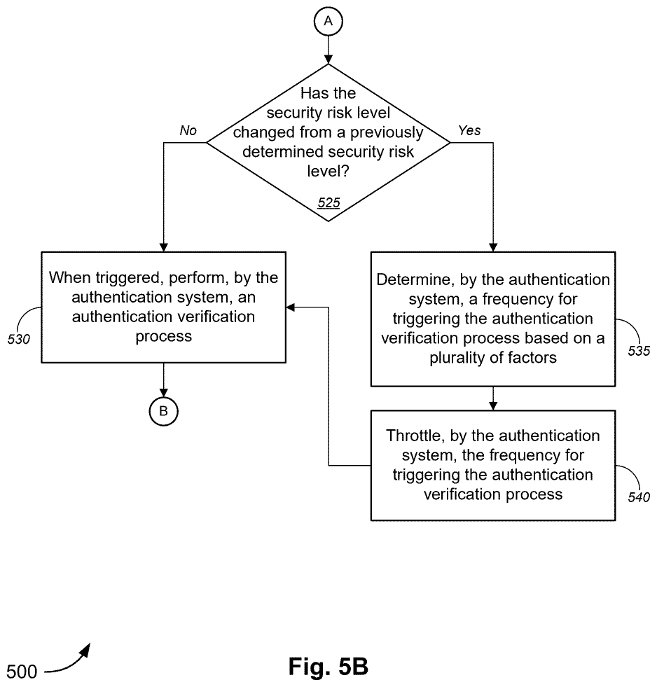

FIGS. 5A and 5B depict yet another example method 500 for implementing biometric authentication-based access to displayed documents or content with modifiable frequency or schedule for triggering authentication processes. With reference to FIGS. 5A and 5B, the operations of example method 500 may be performed by a computing system (e.g., computing system 105 of FIG. 1) and/or components thereof (e.g., authentication system 125 of FIG. 1). Method 500 of FIG. 5A continues onto FIG. 5B following the circular marker denoted, “A,” and returns to FIG. 5A following the circular marker denoted, “B.”

In the example method 500 of FIG. 5, at operation 505, an authentication system determines a security risk level of a displayed content that is displayed on a display device, based on at least one of a lowest level of access permission for any observer of the displayed content or a location setting of the display device. In examples, the authentication system is hosted within a TEE (e.g., TEE 120 of FIG. 1) of a main processor (e.g., main processor(s) 115 of FIG. 1) of a system (e.g., computing system 105 of FIG. 1). Method 500 either continues onto the process at operation 510 or continues onto the process at operation 525 following the circular marker denoted, “A.”

At operation 510, the authentication system determines whether observers of the displayed content are authorized to access the displayed content. When the authentication system determines that each observer is authorized to access the displayed content, method 500 continues onto the process at operation 515, at which the authentication system causes or continues normal (e.g., unmodified) display of the displayed content on the display device. On the other hand, when the authentication system determines that at least one individual among the observers is not authorized to access the displayed content, method 500 continues onto the process at operation 520, at which the authentication system performs one or more actions.

In examples, determining the security risk level of the displayed content (at operation 505) and determining whether the observers are authorized to access the displayed content (at operation 510) are based on information regarding the displayed content. In some examples, the information regarding the displayed content includes at least one of first metadata indicating a level of sensitive information contained within the displayed content, second metadata indicating which fields within the displayed content contain sensitive information, or third metadata indicating which portions of the displayed content contain sensitive information. In some cases, the sensitive information includes at least one of PII, financial information, proprietary information, secret information, national security information, military information, non-child-appropriate content, or exam responses. In some instances, the location setting of the display device is determined based on at least one of location inference data based on a wireless network to which the system is connected or data from one or more location sensors. In some cases, the one or more location sensors includes at least one of a GNSS-based location sensor, a WAPPS-based location sensor, or a CPS-based location sensor. Method 500 continues onto the process at operation 525 following the circular marker denoted, “A.”

With reference to FIG. 5B, at operation 525 (following the circular marker denoted, “A,” in FIG. 5A), method 500 includes the authentication system determining whether the security risk level has changed from a previously determined security risk level. Based on a determination that the security risk level has not changed from the previously determined security risk level, method 500 continues onto the process at operation 530. Based on a determination that the security risk level has changed from the previously determined security risk level, method 500 continues onto the process at operation 535. At operation 530, when triggered, the authentication system performs an authentication verification process. Method 500 returns to the process at operation 510 in FIG. 5A following the circular marker denoted, “B.”

At operation 535, the authentication system determines a frequency for triggering the authentication verification process based on a plurality of factors. In some examples, the plurality of factors include one or more of (i) the security risk level for display of the displayed content, (ii) whether the system is running on battery power or plugged into an electrical outlet, (iii) a frequency of authenticated input signals, (iv) a frequency of unauthenticated input signals, (v) a number of authenticated input signals within a set period, or (vi) a number of unauthenticated input signals within the set period. At operation 540, the authentication system throttles the frequency for triggering the authentication verification process, in some cases, based on the plurality of factors. In some examples, throttling the frequency for triggering the authentication verification process includes one of increasing the frequency, decreasing the frequency, or changing a schedule for triggering the authentication verification process. In examples, method 500 may continue onto the process at operation 530.

In an example, the one or more actions include, for each document, among the displayed content, having a security risk level that exceeds a non-public security threshold level, causing the system to perform one of: (a) blurring at least a portion of that document being displayed on the display device; (b) redacting at least one of textual, numerical, or diagrammatic information contained and displayed within that document; or (c) minimizing that document. In another example, the one or more actions include generating, and displaying on the display device, a message to an authorized user among the observers indicating presence of observers within view of the displayed content being displayed on the display device and warning whether the authorized user would still want to proceed with displaying the displayed content while the system is within the location setting. In yet another example, the one or more actions include causing the system to initiate a screen lock on the display device. In still another example, the one or more actions include generating, and sending to a system administrator, a log indicating at least one of instances where presence of observers within view of the displayed content being displayed on the display device was detected, the frequency for triggering the authentication verification process, or instances that actions were performed in response to the authentication verification process being performed.

In some examples, the one or more actions cause a display of the displayed content on the display device to change from an unmodified state to a modified state. In examples, the authentication verification process further includes, based on a determination that there are no unauthorized observers within view of the displayed content, performing one of continuing the display of the displayed content in an unmodified state or causing the display of the displayed content to return from the modified state to the unmodified state. In some cases, the authentication verification process is further triggered by at least one of a user-initiated trigger, detection of motion of at least one observer away from the system, elapsing of a first count-down timer that is started after a latest triggering of the authentication verification process, or elapsing of a second count-down timer that is started after cessation of motion in front of the display device. In examples, the observers are detected by a camera, and determining whether the observers are authorized to access the displayed content is based on access permission granted by facial recognition. In some examples, the one or more actions include denying the at least one observer access to the displayed content, and displaying a message indicating that access to the displayed content is denied. In some cases, the authentication verification process further includes capturing one or more audio signals using one or more microphones, and determining whether the observers are within viewing range of the displayed content based on analysis of the one or more audio signals.

While the techniques and procedures in methods 300, 400, and 500 are depicted and/or described in a certain order for purposes of illustration, it should be appreciated that certain procedures may be reordered and/or omitted within the scope of various embodiments. Moreover, while the methods 300, 400, and 500 may be implemented by or with (and, in some cases, are described below with respect to) the systems, examples, or embodiments 100 and 200 of FIGS. 1 and 2A-2B, respectively (or components thereof), such methods may also be implemented using any suitable hardware (or software) implementation. Similarly, while each of the systems, examples, or embodiments 100 and 200 of FIGS. 1 and 2A-2B, respectively (or components thereof), can operate according to the methods 300, 400, and 500 (e.g., by executing instructions embodied on a computer readable medium), the systems, examples, or embodiments 100 and 200 of FIGS. 1 and 2A-2B can each also operate according to other modes of operation and/or perform other suitable procedures.

As should be appreciated from the foregoing, the present technology provides multiple technical benefits and solutions to technical problems. For instance, ensuring protection of sensitive information being displayed on a display screen of a device generally raises multiple technical problems. For example, one technical problem includes a lack of balance, or a lack of existing frameworks or platforms for providing a balance, between providing checks to protect the sensitive information being displayed and avoiding interruption of workflow with the sensitive information (or the user experience in interacting with or consuming the sensitive information). The present technology provides for biometric authentication-based access to displayed documents or content with modifiable frequency or schedule for triggering authentication processes. The present technology utilizes real-time threat intelligence, drawing from factors including the current location of the computing system, the network the computing system is connected to, and other relevant contextual information, to enable the authentication system of the computing system to dynamically adjust the frequency and intensity of its authentication verification process checks. By taking all of these factors into account, the system can strike a balance that enhances security without placing an undue burden on system resources or negatively impacting the user experience. In the manner as described above, the authentication verification process (and the process for setting or modifying trigger frequency or schedule) enhances reliability, and improves security of sensitive information being displayed (or being accessed for display) on the display screen of a computing system.

In an aspect, the technology relates to a system, including an authentication system that executes computer executable instructions that cause the authentication system to perform operations. The operations include determining a security risk level of a displayed content that is displayed on a display device, based on at least one of a lowest level of access permission for any observer of the displayed content or a location setting of the display device. The operations further include determining whether observers of the displayed content are authorized to access the displayed content. The operations further include, when the authentication system determines that at least one individual among the observers is not authorized to access the displayed content, performing one or more actions.

In some examples, a main processor including a TEE, wherein the authentication system is hosted within the TEE. In examples, determining the security risk level of the displayed content and determining whether the observers are authorized to access the displayed content are based on information regarding the displayed content. In some cases, the information regarding the displayed content includes at least one of first metadata indicating a level of sensitive information contained within the displayed content, second metadata indicating which fields within the displayed content contain sensitive information, or third metadata indicating which portions of the displayed content contain sensitive information. In some instances, the sensitive information includes at least one of PII, financial information, proprietary information, secret information, national security information, military information, non-child-appropriate content, or exam responses. In some examples, the location setting of the display device is determined based on at least one of location inference data based on a wireless network to which the system is connected or data from one or more location sensors. In some cases, the one or more location sensors include at least one of a GNSS-based location sensor, a WAPPS-based location sensor, or a CPS-based location sensor.

In examples, the operations further include, based on a determination that the security risk level has changed from a previously determined security risk level, throttling a frequency for triggering an authentication verification process based on the security risk level. In some cases, throttling the frequency for triggering the authentication verification process includes one of increasing the frequency, decreasing the frequency, or changing a schedule for triggering the authentication verification process. In some instances, the operations further include determining the frequency for triggering the authentication verification process based on a plurality of factors including one or more of the security risk level for display of the displayed content, whether the system is running on battery power or plugged into an electrical outlet, a frequency of authenticated input signals, a frequency of unauthenticated input signals, a number of authenticated input signals within a set period, or a number of unauthenticated input signals within the set period. In some examples, the authentication verification process further includes capturing one or more audio signals using one or more microphones; and determining whether the observers are within viewing range of the displayed content based on analysis of the one or more audio signals.

In an example, the one or more actions include at least one of, for each document, among the displayed content, having a security risk level that exceeds a non-public security threshold level, causing the system to perform one of: blurring at least a portion of that document being displayed on the display device; redacting at least one of textual, numerical, or diagrammatic information contained and displayed within that document; or minimizing that document. In another example, the one or more actions further include generating, and displaying on the display device, a message to an authorized user among the observers indicating presence of observers within view of the displayed content being displayed on the display device and warning whether the authorized user would still want to proceed with displaying the displayed content while the system is within the location setting. In yet another example, the one or more actions further include causing the system to initiate a screen lock on the display device. In still another example, the one or more actions further include generating, and sending to a system administrator, a log indicating at least one of instances where presence of observers within view of the displayed content being displayed on the display device was detected, the frequency for triggering the authentication verification process, or instances that actions were performed in response to the authentication verification process being performed.

In some examples, the one or more actions cause a display of the displayed content on the display device to change from an unmodified state to a modified state. In some cases, the authentication verification process further includes, based on a determination that there are no unauthorized observers within view of the displayed content, performing one of continuing the display of the displayed content in an unmodified state or causing the display of the displayed content to return from the modified state to the unmodified state. In some instances, the authentication verification process is further triggered by at least one of a user-initiated trigger, detection of motion of at least one observer away from the system, elapsing of a first count-down timer that is started after a latest triggering of the authentication verification process, or elapsing of a second count-down timer that is started after cessation of motion in front of the display device.

In examples, the observers are detected by a camera, where determining whether the observers are authorized to access the displayed content is based on access permission granted by facial recognition. In some cases, the one or more actions include: denying the at least one observer access to the displayed content; and displaying a message indicating that access to the displayed content is denied.

In another aspect, the technology relates to a computer-implemented method, including receiving, by a computing system, a plurality of data including at least one of location data indicating a current location of the computing system or document security level data indicating a security risk level for each document among displayed content being accessed. In some examples, the method further includes determining, by the computing system, a security risk level for display of the displayed content on a display device of the computing system while the computing system is located within the current location, based on a combination of data among the plurality of data. In examples, the method further includes setting or modifying, by the computing system, at least one of a frequency or a schedule for triggering an authentication verification process, based on the security risk level for display of the displayed content. In some examples, the authentication verification process, when triggered, include determining, by the computing system, whether observers of the displayed content are authorized to access the displayed content. In examples, the authentication verification process, when triggered, further includes, when the computing system determines that at least one individual among the observers is not authorized to access the displayed content being displayed on the display device, performing, by the computing system, one or more actions.

In examples, the computing system includes a main processor, a TEE within the main processor, and an authentication system that is executed within the TEE. In some instances, receiving the plurality of data, determining the security risk level, setting or modifying the at least one of the frequency or the schedule for triggering the authentication verification process, and the authentication verification process are performed by the authentication system. In some cases, the location data includes at least one of location inference data based on a wireless network to which the computing system is connected, GNSS-based location data, WAPPS-based location data, or CPS-based location data.

In some examples, setting or modifying the at least one of the frequency or the schedule for triggering the authentication verification process is further based on one or more of a frequency of authenticated input signals, a frequency of unauthenticated input signals, a number of authenticated input signals within a set period, or a number of unauthenticated input signals within the set period, or whether the computing system is running on battery power or plugged into an electrical outlet. In some instances, the observers are detected by a camera, wherein determining whether the observers are authorized to access the displayed content is based on access permission granted by facial recognition. In some cases, the authentication verification process further includes: capturing one or more audio signals using one or more microphones of the computing system; and determining whether the observers are within viewing range of the displayed content based on analysis of the one or more audio signals.

In an example, the one or more actions include, for each document, among the displayed content, having a security risk level that exceeds a non-public security threshold level, causing the computing system to perform at least one of: blocking display of that document; or generating, and displaying on the display device, a message to an authorized user among the observers indicating presence of observers within view of the displayed content being displayed on the display device and warning whether the authorized user would still want to proceed with accessing and displaying the displayed content while the computing system is within the current location. In another example, the one or more actions further include, for each document, among the displayed content, having a security risk level that exceeds the non-public security threshold level, causing the computing system to perform one of: blurring at least a portion of that document being displayed on the display device; redacting at least one of textual, numerical, or diagrammatic information contained and displayed within that document; or minimizing that document. In yet another example, the one or more actions further include causing the computing system to initiate a screen lock on the display device. In still another example, the one or more actions further include generating, and sending to a system administrator, a log indicating at least one of instances where presence of observers within view of the displayed content being displayed on the display device or being accessed for display on the display device was detected, the at least one of the frequency or the schedule for triggering the authentication verification process, or instances that actions were performed in response to the authentication verification process being performed.

In yet another aspect, the technology relates to a computing system, including a main processor including a TEE; and an authentication system that runs within the TEE and that executes computer executable instructions that cause the authentication system to perform operations. The operations include receiving a plurality of data including at least one of location data indicating a current location of the computing system or document security level data indicating a security risk level for each document among displayed content being accessed. The operations further include determining a security risk level for display of the displayed content on a display device while the computing system is located within the current location, based on a combination of data among the plurality of data. The operations further include setting or modifying at least one of a frequency or a schedule for triggering an authentication verification process, based on the security risk level for display of the displayed content. In some examples, the authentication verification process, when triggered, includes determining whether observers of the displayed content are authorized to access the displayed content; and when the computing system determines that at least one individual among the observers is not authorized to access the displayed content being displayed on the display device, performing one or more actions.

In examples, setting or modifying the at least one of the frequency or the schedule for triggering the authentication verification process is further based on one or more of a frequency of authenticated input signals, a frequency of unauthenticated input signals, a number of authenticated input signals within a set period, or a number of unauthenticated input signals within the set period, or whether the computing system is running on battery power or plugged into an electrical outlet. In some cases, the observers are detected by a camera, wherein determining whether the observers are authorized to access the displayed content is based on access permission granted by facial recognition. In some instances, the authentication verification process further includes: capturing one or more audio signals using one or more microphones; and determining whether the observers are within viewing range of the displayed content based on analysis of the one or more audio signals.

In an example, the one or more actions include, for each document, among the displayed content, having a security risk level that exceeds a non-public security threshold level, causing the computing system to perform at least one of: blocking display of that document; or generating, and displaying on the display device, a message to an authorized user among the observers indicating presence of observers within view of the displayed content being displayed on the display device and warning whether the authorized user would still want to proceed with accessing and displaying the displayed content while the computing system is within the current location. In another example, the one or more actions further include for each document, among the displayed content, having a security risk level that exceeds the non-public security threshold level, causing the computing system to perform one of: blurring at least a portion of that document being displayed on the display device; redacting at least one of textual, numerical, or diagrammatic information contained and displayed within that document; or minimizing that document. In yet another example, the one or more actions further include causing the computing system to initiate a screen lock on the display device; or generating, and sending to a system administrator, a log indicating at least one of instances where presence of observers within view of the displayed content being displayed on the display device or being accessed for display on the display device was detected, the at least one of the frequency or the schedule for triggering the authentication verification process, or instances that actions were performed in response to the authentication verification process being performed.

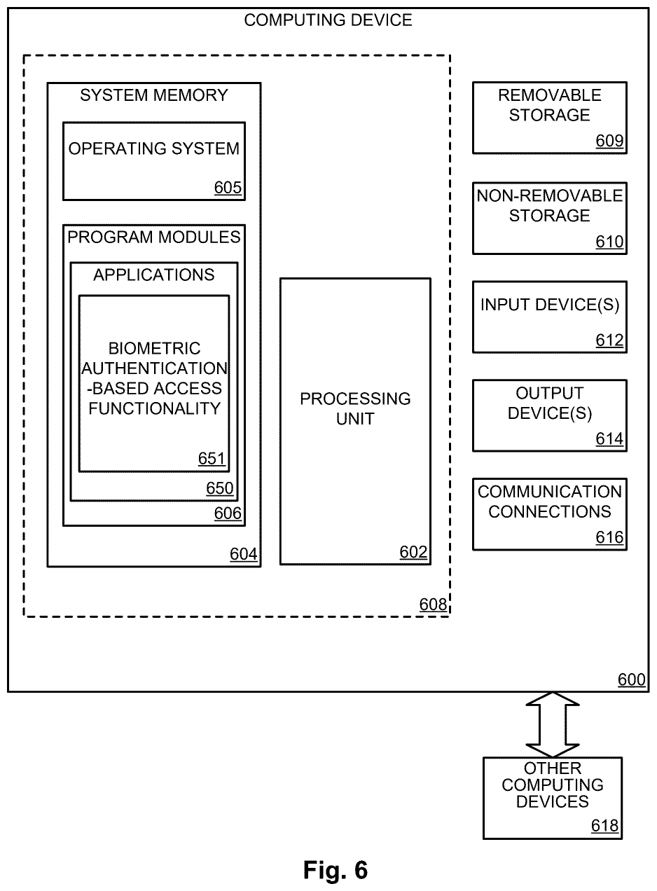

FIG. 6 depicts a block diagram illustrating physical components (i.e., hardware) of a computing device 600 with which examples of the present disclosure may be practiced. The computing device components described below may be suitable for a client device implementing the biometric authentication-based access to displayed documents or content with modifiable frequency or schedule for triggering authentication processes, as discussed above. In a basic configuration, the computing device 600 may include at least one processing unit 602 and a system memory 604. The processing unit(s) (e.g., processors) may be referred to as a processing system. Depending on the configuration and type of computing device, the system memory 604 may include volatile storage (e.g., random access memory), non-volatile storage (e.g., read-only memory), flash memory, or any combination of such memories. The system memory 604 may include an operating system 605 and one or more program modules 606 suitable for running software applications 650, such as biometric authentication-based access functionality 651 with modifiable frequency or schedule for triggering authentication processes, to implement one or more of the systems or methods described above.

The operating system 605, for example, may be suitable for controlling the operation of the computing device 600. Furthermore, aspects of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionalities. For example, the computing device 600 may also include additional data storage devices (which may be removable and/or non-removable), such as, for example, magnetic disks, optical disks, or tape. Such additional storage is illustrated in FIG. 6 by a removable storage device(s) 609 and a non-removable storage device(s) 610.

As stated above, a number of program modules and data files may be stored in the system memory 604. While executing on the processing unit 602, the program modules 606 may perform processes including one or more of the operations of the method(s) as illustrated in FIGS. 3A-5B, or one or more operations of the system(s) and/or apparatus(es) as described with respect to FIGS. 1-2B, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 6 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 600 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 600 may also have one or more input devices 612 such as a keyboard, a mouse, a pen, a sound input device, and/or a touch input device, etc. The output device(s) 614 such as a display, speakers, and/or a printer, etc. may also be included. The aforementioned devices are examples and others may be used. The computing device 600 may include one or more communication connections 616 allowing communications with other computing devices 618. Examples of suitable communication connections 616 include radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 604, the removable storage device 609, and the non-removable storage device 610 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A system, comprising:
an authentication system that executes computer executable instructions that cause the authentication system to perform operations comprising:
determining a security risk level of a displayed content that is displayed on a display device, based on at least one of a lowest level of access permission for any observer of the displayed content or a location setting of the display device;
determining whether observers of the displayed content are authorized to access the displayed content; and
when the authentication system determines that at least one individual among the observers is not authorized to access the displayed content, performing one or more actions.

2. The system of claim 1, further comprising:
a main processor including a trusted execution environment (“TEE”), wherein the authentication system is hosted within the TEE.

3. The system of claim 1, wherein determining the security risk level of the displayed content and determining whether the observers are authorized to access the displayed content are based on information regarding the displayed content, the information regarding the displayed content including at least one of first metadata indicating a level of sensitive information contained within the displayed content, second metadata indicating which fields within the displayed content contain sensitive information, or third metadata indicating which portions of the displayed content contain sensitive information, wherein the sensitive information includes at least one of personally identifiable information (“PII”), financial information, proprietary information, secret information, national security information, military information, non-child-appropriate content, or exam responses.

4. The system of claim 1, wherein the location setting of the display device is determined based on at least one of location inference data based on a wireless network to which the system is connected or data from one or more location sensors, wherein the one or more location sensors comprise at least one of a global navigation satellite system (“GNSS”)-based location sensor, a wireless access point (“WAP”)-based positioning system (“WAPPS”)-based location sensor, or a cellular positioning system (“CPS”)-based location sensor.

5. The system of claim 1, wherein the operations further comprise:
based on a determination that the security risk level has changed from a previously determined security risk level, throttling a frequency for triggering an authentication verification process based on the security risk level;
wherein throttling the frequency for triggering the authentication verification process includes one of increasing the frequency, decreasing the frequency, or changing a schedule for triggering the authentication verification process.

6. The system of claim 5, wherein the operations further comprise:
determining the frequency for triggering the authentication verification process based on a plurality of factors including one or more of the security risk level for display of the displayed content, whether the system is running on battery power or plugged into an electrical outlet, a frequency of authenticated input signals, a frequency of unauthenticated input signals, a number of authenticated input signals within a set period, or a number of unauthenticated input signals within the set period.

7. The system of claim 5, wherein the authentication verification process further comprises:
capturing one or more audio signals using one or more microphones; and
determining whether the observers are within viewing range of the displayed content based on analysis of the one or more audio signals.

8. The system of claim 5, wherein the one or more actions comprise at least one of:
for each document, among the displayed content, having a security risk level that exceeds a non-public security threshold level, causing the system to perform one of:
blurring at least a portion of that document being displayed on the display device;
redacting at least one of textual, numerical, or diagrammatic information contained and displayed within that document; or
minimizing that document;
generating, and displaying on the display device, a message to an authorized user among the observers indicating presence of observers within view of the displayed content being displayed on the display device and warning whether the authorized user would still want to proceed with displaying the displayed content while the system is within the location setting;
causing the system to initiate a screen lock on the display device; or
generating, and sending to a system administrator, a log indicating at least one of instances where presence of observers within view of the displayed content being displayed on the display device was detected, the frequency for triggering the authentication verification process, or instances that actions were performed in response to the authentication verification process being performed.

9. The system of claim 5, wherein the one or more actions cause a display of the displayed content on the display device to change from an unmodified state to a modified state, wherein the authentication verification process further comprises:
based on a determination that there are no unauthorized observers within view of the displayed content, performing one of continuing the display of the displayed content in an unmodified state or causing the display of the displayed content to return from the modified state to the unmodified state;
wherein the authentication verification process is further triggered by at least one of a user-initiated trigger, detection of motion of at least one observer away from the system, elapsing of a first count-down timer that is started after a latest triggering of the authentication verification process, or elapsing of a second count-down timer that is started after cessation of motion in front of the display device.

10. The system of claim 1, wherein the observers are detected by a camera, wherein determining whether the observers are authorized to access the displayed content is based on access permission granted by facial recognition, wherein the one or more actions comprise:
denying the at least one observer access to the displayed content; and
displaying a message indicating that access to the displayed content is denied.

11. A computer-implemented method, comprising:
receiving, by a computing system, a plurality of data including at least one of location data indicating a current location of the computing system or document security level data indicating a security risk level for each document among displayed content being accessed;
determining, by the computing system, a security risk level for display of the displayed content on a display device of the computing system while the computing system is located within the current location, based on a combination of data among the plurality of data; and
setting or modifying, by the computing system, at least one of a frequency or a schedule for triggering an authentication verification process, based on the security risk level for display of the displayed content, the authentication verification process, when triggered, comprising:
determining, by the computing system, whether observers of the displayed content are authorized to access the displayed content; and
when the computing system determines that at least one individual among the observers is not authorized to access the displayed content being displayed on the display device, performing, by the computing system, one or more actions.

12. The computer-implemented method of claim 11, wherein the computing system includes a main processor, a trusted execution environment (“TEE”) within the main processor, and an authentication system that is executed within the TEE, wherein receiving the plurality of data, determining the security risk level, setting or modifying the at least one of the frequency or the schedule for triggering the authentication verification process, and the authentication verification process are performed by the authentication system.

13. The computer-implemented method of claim 11, wherein the location data includes at least one of location inference data based on a wireless network to which the computing system is connected, global navigation satellite system (“GNSS”)-based location data, wireless access point (“WAP”)-based positioning system (“WAPPS”)-based location data, or cellular positioning system (“CPS”)-based location data.

14. The computer-implemented method of claim 11, wherein setting or modifying the at least one of the frequency or the schedule for triggering the authentication verification process is further based on one or more of a frequency of authenticated input signals, a frequency of unauthenticated input signals, a number of authenticated input signals within a set period, or a number of unauthenticated input signals within the set period, or whether the computing system is running on battery power or plugged into an electrical outlet.

15. The computer-implemented method of claim 11, wherein the observers are detected by a camera, wherein determining whether the observers are authorized to access the displayed content is based on access permission granted by facial recognition, wherein the authentication verification process further comprises:
capturing one or more audio signals using one or more microphones of the computing system; and
determining whether the observers are within viewing range of the displayed content based on analysis of the one or more audio signals.

16. The computer-implemented method of claim 11, wherein the one or more actions comprise at least one of:
for each document, among the displayed content, having a security risk level that exceeds a non-public security threshold level, causing the computing system to perform at least one of:
blocking display of that document; or
generating, and displaying on the display device, a message to an authorized user among the observers indicating presence of observers within view of the displayed content being displayed on the display device and warning whether the authorized user would still want to proceed with accessing and displaying the displayed content while the computing system is within the current location;
for each document, among the displayed content, having a security risk level that exceeds the non-public security threshold level, causing the computing system to perform one of:
blurring at least a portion of that document being displayed on the display device;
redacting at least one of textual, numerical, or diagrammatic information contained and displayed within that document; or
minimizing that document;
causing the computing system to initiate a screen lock on the display device; or
generating, and sending to a system administrator, a log indicating at least one of instances where presence of observers within view of the displayed content being displayed on the display device or being accessed for display on the display device was detected, the at least one of the frequency or the schedule for triggering the authentication verification process, or instances that actions were performed in response to the authentication verification process being performed.

17. A computing system, comprising:
a main processor including a trusted execution environment (“TEE”); and
an authentication system that runs within the TEE and that executes computer executable instructions that cause the authentication system to perform operations comprising:
receiving a plurality of data including at least one of location data indicating a current location of the computing system or document security level data indicating a security risk level for each document among displayed content being accessed;
determining a security risk level for display of the displayed content on a display device while the computing system is located within the current location, based on a combination of data among the plurality of data; and
setting or modifying at least one of a frequency or a schedule for triggering an authentication verification process, based on the security risk level for display of the displayed content, the authentication verification process, when triggered, comprising:
determining whether observers of the displayed content are authorized to access the displayed content; and
when the computing system determines that at least one individual among the observers is not authorized to access the displayed content being displayed on the display device, performing one or more actions.

18. The computing system of claim 17, wherein setting or modifying the at least one of the frequency or the schedule for triggering the authentication verification process is further based on one or more of a frequency of authenticated input signals, a frequency of unauthenticated input signals, a number of authenticated input signals within a set period, or a number of unauthenticated input signals within the set period, or whether the computing system is running on battery power or plugged into an electrical outlet.

19. The computing system of claim 17, wherein the observers are detected by a camera, wherein determining whether the observers are authorized to access the displayed content is based on access permission granted by facial recognition, wherein the authentication verification process further comprises:
capturing one or more audio signals using one or more microphones; and
determining whether the observers are within viewing range of the displayed content based on analysis of the one or more audio signals.

20. The computing system of claim 17, wherein the one or more actions comprise at least one of:
for each document, among the displayed content, having a security risk level that exceeds a non-public security threshold level, causing the computing system to perform at least one of:
blocking display of that document; or
generating, and displaying on the display device, a message to an authorized user among the observers indicating presence of observers within view of the displayed content being displayed on the display device and warning whether the authorized user would still want to proceed with accessing and displaying the displayed content while the computing system is within the current location;
for each document, among the displayed content, having a security risk level that exceeds the non-public security threshold level, causing the computing system to perform one of:
blurring at least a portion of that document being displayed on the display device;
redacting at least one of textual, numerical, or diagrammatic information contained and displayed within that document; or
minimizing that document;
causing the computing system to initiate a screen lock on the display device; or
generating, and sending to a system administrator, a log indicating at least one of instances where presence of observers within view of the displayed content being displayed on the display device or being accessed for display on the display device was detected, the at least one of the frequency or the schedule for triggering the authentication verification process, or instances that actions were performed in response to the authentication verification process being performed.
